(19) United States
(12) Patent Application Publication
(10) Pub. No.: US 2015/0046178 A1
(43) Pub. Date: Feb. 12, 2015

(54) Method of Expediting Medical Diagnosis Code Selection by Executing Computer-Executable Instructions Stored On a Non-Transitory Computer-Readable Medium

(71) Applicant: Pawan Jindal, Ofallon, MO (US)

(72) Inventor: Pawan Jindal, Ofallon, MO (US)

(73) Assignee: NEMO CAPITAL PARTNERS, LLC, Princeton, NJ (US)

(21) Appl. No.: 14/453,460

(22) Filed: Aug. 6, 2014

Related U.S. Application Data
(60) Provisional application No. 61/862,890, filed on Aug. 6, 2013.

(51) Int. Cl. G06F 19/00

(52) U.S. Cl. CPC G06F 19/3406
USPC 705/2

(57) ABSTRACT

A method of expediting medical diagnosis code selection by executing computer-executable instructions stored on a non-transitory computer-readable medium provides a means for healthcare providers to quickly and efficiently select appropriate medical diagnosis codes by providing electronic cheat sheets within a computer program environment. An electronic cheat sheet, or customized reference sheet, contains elements that function as pointers to elements in a database of medical diagnosis codes which has a branching hierarchal structure and can be graphically navigated.

The current application claims a priority to the U.S. Provisional Patent application Ser. No. 61/862,890 filed on Aug. 6, 2013.

### FIELD OF THE INVENTION

The present invention relates generally to medicine. More particularly, the present invention is a method for efficiently selecting medical diagnosis codes.

### BACKGROUND OF THE INVENTION

Medical providers are eligible for the receipt of payments from governmental agencies upon providing certain care. Providers are required by statute and regulation to meet particular standards, in reporting and requesting payment, for the purpose of avoiding the commitment of fraud and abuse in requesting and receiving such payment. The provider must properly and correctly code the diagnosis of the patient to form the basis for meeting regulatory requirements required for payment. Incorrect coding may likely result in payments being denied and noncompliance with laws or regulations such as the Federal False Claims Act (31 USC 3729), the Health Insurance Portability and Accountability Act (HIPAA), Stark I and II and similar Federal and State laws enacted to protect against fraudulent claims for reimbursement for the providing of health care. Medical providers are thus exposed to criminal and civil penalties relating to compliance with regulatory and statutory requirements.

For the last 3 decades, medical providers have been using ICD-9 system for reporting patient diagnosis. As of Oct. 1, 2015 all healthcare providers would be required to start using a new version of coding called ICD-10. The changes in the ICD version increased the number of available diagnosis code from around 14,000 to around 70,000. Traditionally, providers have used “Cheat Sheets” in their practice for selecting patient diagnosis based on ICD-9. Cheat Sheets contain the most common codes for a healthcare provider summarized on one or more sheets of paper. The increase in the number of ICD codes in version 10 makes it very difficult to continue with cheat sheets. For example, there is a single diagnosis code for fracture of patella in ICD-9. That single code now translates to more than 100 codes in ICD-10 due to the specificity required in ICD-10 codes. It is very difficult to put all those codes on a “cheat sheet”. Due to the increase in the number of codes and the required specificity and complexity of ICD-10 codes, this change has been referred to many experts as the end of cheat sheets. It increases in staffing and advanced training. It has been recommended as a means of addressing the burden of correct coding to ensure accurate selection of diagnosis codes and compliance with regulatory requirements. However, the specificity required for each diagnosis have left the human element in place and leaving the healthcare provider with the difficult burden of correctly and accurately selecting the most appropriate code for each patient. The provider is required to spend the additional time for searching the right code, is exposed to the hazard of forgetting one or more guidelines thus leading to increased denied claims.

### BRIEF DESCRIPTION OF THE DRAWINGS

FIG. 1 is a stepwise flow diagram describing the general process of the present invention.

FIG. 2 is a stepwise flow diagram describing steps for selecting the at least one desired element.

FIG. 3 is a stepwise flow diagram describing steps for utilizing multiple customized reference sheets.

FIG. 4 is a stepwise flow diagram describing steps for verifying the final diagnosis element as a leaf node.

FIG. 5 is a stepwise flow diagram describing steps for verifying the final diagnosis element as a complying with a plurality of regulations.

FIG. 6 is a stepwise flow diagram describing steps for verifying the final diagnosis element as a complying with a custom diagnosis submittal rule.

### DETAIL DESCRIPTIONS OF THE INVENTION

All illustrations of the drawings are for the purpose of describing selected versions of the present invention and are not intended to limit the scope of the present invention. The present invention is to be described in detail and is provided in a manner that establishes a thorough understanding of the present invention. There may be aspects of the present invention that may be practiced without the implementation of some features as they are described. It should be understood that some details have not been described in detail in order to not unnecessarily obscure focus of the invention.

The present invention relates to a method for electronic coding of medical diagnosis using the International Classification of Diseases, tenth revision or ICD-10, for compliance with Federal and State statutory and regulatory requirements for the avoidance of fraud and abuse in application for reimbursement from governmental agencies for services rendered pursuant to regulations including Health Care Financing, Medicare and Department of Health and Human Services regulations.

The present invention is directed toward a digital computer program for use by health care providers for selecting the most detailed and accurate ICD-10 diagnosis codes from a predefined list of high level codes. The present invention establishes a process for creating and using dynamic electronic cheat sheets for selecting correct ICD-10 diagnosis codes required for reimbursement for care delivered. The present invention is directed to a computer and computer program wherein a computer program carries out the method of the present invention in addition to performing a series of checks prior to the final selection of the diagnosis code for a patient to ensure compliance with statutory and regulatory requirements.

The preferred embodiment of the invention provides a method to maximize efficiency and accuracy for the provider in determining and documenting correct ICD-10 codes as required for agency reimbursement for health care delivered. The approximately 70,000 codes of ICD-10 are arranged in a hierarchal structure. The top level structure is divided into chapters. Codes in each chapter have further hierarchies defined. The hierarchal structure goes from least specific to most specific codes.

Healthcare providers are required to always select the last level code, or leaf node, in a hierarchy in order for the code to be considered valid for submittal. In other words, the healthcare provider is required to select the code which provides the most specific code for the diagnosis under consideration.

The present invention provides a means for easy and efficient selection of ICD-10 diagnosis through an “electronic cheat sheet.” The electronic cheat sheet allows healthcare providers to create a custom list of common diagnoses for easy reference. However, to keep the number of items in the electronic cheat sheet at a manageable level, the healthcare provider can add the diagnosis at any level in the hierarchy. The electronic cheat sheet saves the healthcare provider from having to search through the entire list of codes to select the most detailed level code. The present invention provides the best combination of a manageable list of items in an electronic cheat sheet while ensuring accuracy and efficiency of code selection at the time of assigning the diagnosis to a patient. The present invention is therefore a highly effective system in helping healthcare providers selecting an ICD-10 code quickly, efficiently and accurately for every patient encounter.

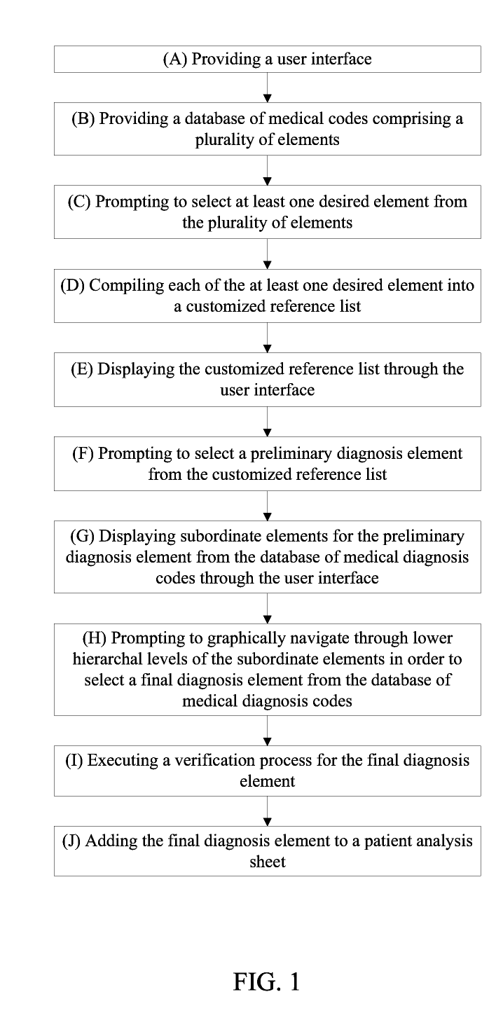

As shown in FIG. 1, the method in the preferred embodiment of the present invention is as follows. A user interface is provided. In the preferred embodiment, the user interface is any computing device capable of receiving user input and displaying visual output, such as, but not limited to, a desktop computer, a laptop computer, a mobile device such as a tablet computer or mobile phone, or another computing device. The ICD-10 codes are hereinafter referred to as a database of medical diagnosis codes. The database of medical diagnosis codes comprises a plurality of elements, wherein the plurality of elements is organized in a branching hierarchy, and wherein each of the plurality of elements is associated with a hierarchal level.

In order to create an electronic cheat sheet, hereinafter referred to as a customized reference list, a user is prompted to select at least one desired element from the plurality of elements. Each of the at least one desired element is compiled into a customized reference list. The at least one desired element may be any element from the database of medical codes, and may be associated with any one of the hierarchal levels. In one example, the at least one desired element refers to a somewhat detailed group of diagnoses, such as, for example, a general “Migraine” element, which is a subordinate element to “Episodic and paroxysmal disorders,” which is a subordinate element to “Diseases of the nervous system.” The “Migraine” element itself comprises a plurality of subordinate, more specific elements, such as “Migraine with aura” or “Hemiplegic migraine”, each of which may themselves comprise further subordinate elements which subsequently further narrow the diagnosis until reaching a leaf node, or the element with the highest level of detail. Alternately, the at least one desired element may be an element in the highest level, or chapter, or the at least one desired element may be a leaf node, though these situations are considered to be unlikely.

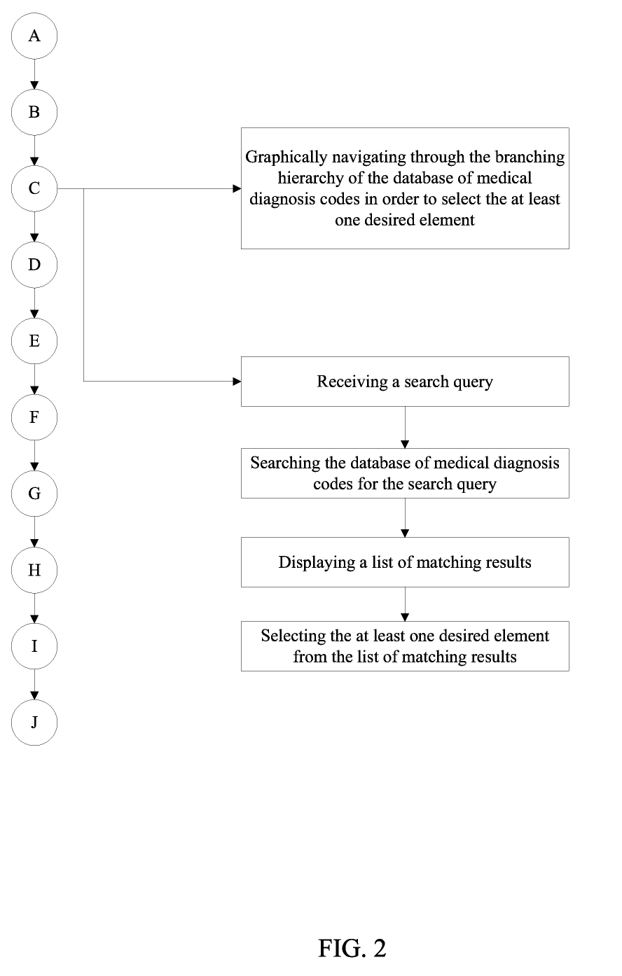

Referring to FIG. 2, in the preferred embodiment, this initial selection of elements for the customized reference list takes place in a graphical interface environment on the computing device, with the branching hierarchal structure is visually displayed on the user interface and able to be graphically navigated by the user by expanding various elements in order to view subordinate elements and select the at least one desired element. Alternatively, the user may enter a search query, and the database of medical diagnosis codes is searched for the search query. A list of matching results is displayed, wherein the matching results are determined by a search algorithm, and the at least one desired element is selected from the list of matching results.

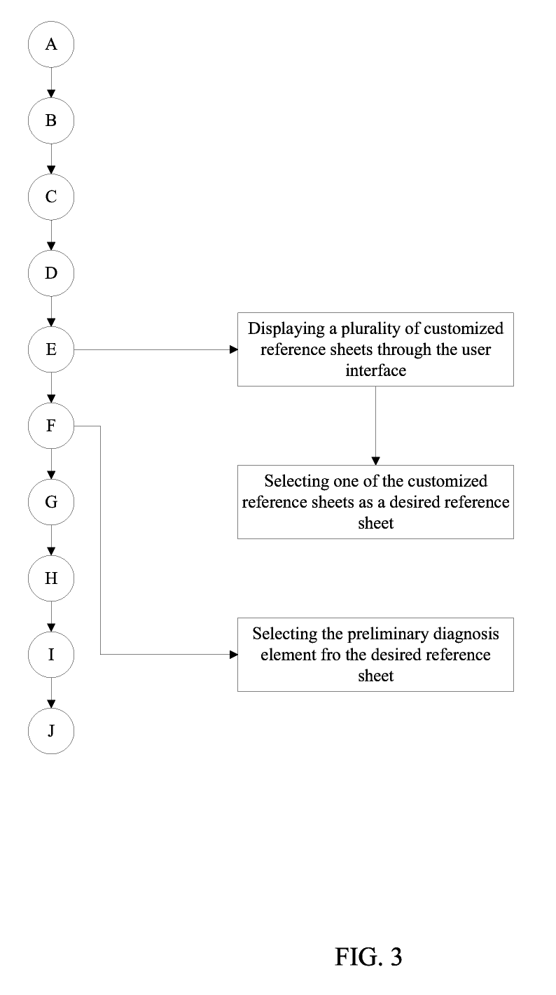

The customized reference list may be created in a variety of ways. The customized reference list may be pre-determined across an entire practice, or multiple practitioners may create their own customized reference lists. It is also contemplated that in one embodiment of the present invention a customized reference list may be generated by an algorithm. In reference to FIG. 3, multiple customized reference lists may be created. In this case, a plurality of customized reference sheets is displayed through the user interface. One of the customized reference sheets is selected as a desired reference sheet, and the preliminary diagnosis element is selected from the desired reference sheet.

In the preferred embodiment of the present invention, each element on the customized reference list functions as a pointer to a location in the database of medical diagnosis codes. To utilize the customized reference list, the customized reference list is displayed through the user interface. The user is prompted to select a preliminary diagnosis element from the customized reference list, which leads the user to a location in the database of medical diagnoses that the preliminary diagnosis element refers to.

Upon receiving the preliminary diagnosis element selection, subordinate elements for the preliminary diagnosis element from the database of medical diagnosis codes are displayed through the user interface. The user is then prompted to graphically navigate through lower hierarchal levels of the subordinate elements in order to select a final diagnosis element from the database of medical diagnosis codes.

A verification process is then executed for the final diagnosis element, and the final diagnosis element is added to a patient analysis sheet. In the preferred embodiment, the patient analysis sheet is a digital list in the computer program of the present invention listing all medical diagnosis codes the practitioner has assigned to the patient. The verification process involves a series of checks to ensure that the final diagnosis element is a valid selection.

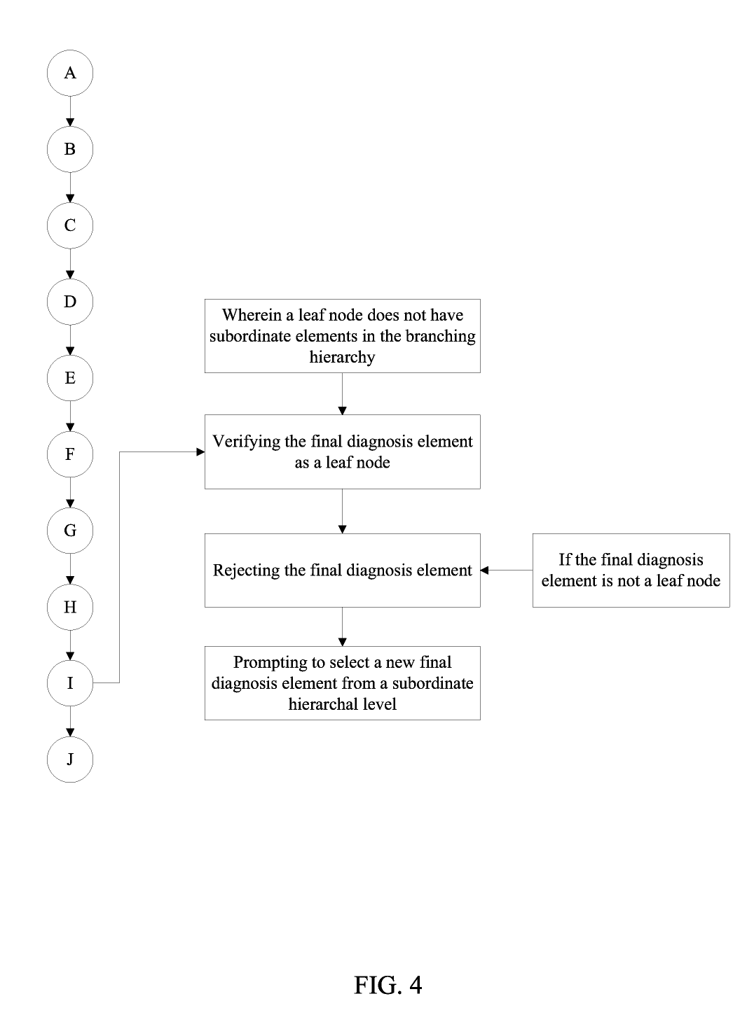

As shown in FIG. 4, one check the present invention does is to ensure that the final diagnosis element is a leaf node, wherein the leaf node does not have subordinate elements in the branching hierarchy and is the most specific, detailed code in the hierarchy. In the preferred embodiment, the final diagnosis element is rejected if the final diagnosis element is not a leaf note, and the user is prompted to select a new, more specific final diagnosis element from a subordinate hierarchal level. It is contemplated that in alternate embodiments every final diagnosis element may not be required to be a leaf node, and for some diagnoses elements from hierarchal levels superior to a leaf node in the hierarchy may be selected as the final diagnosis element.

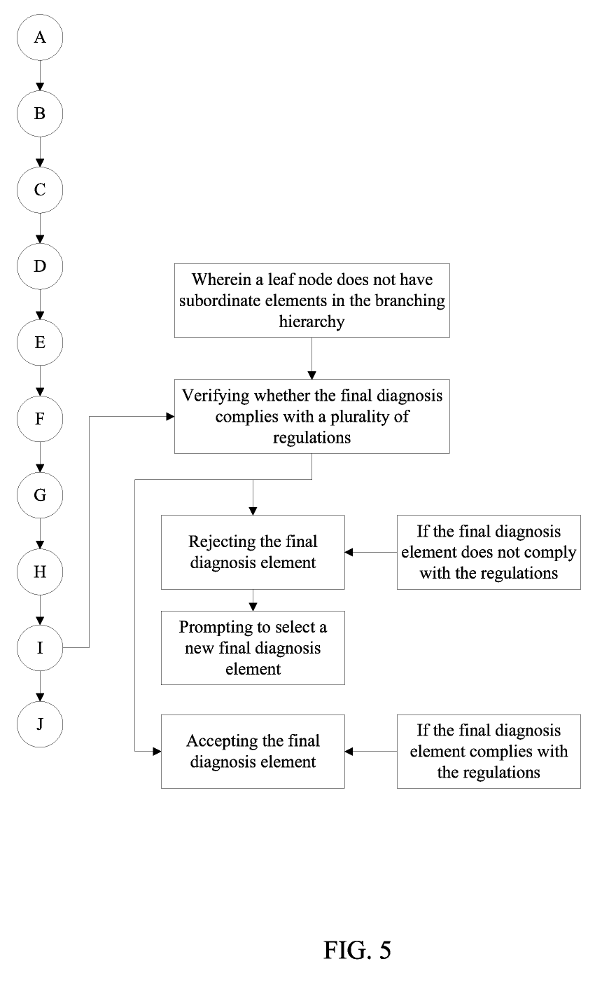

The preferred embodiment of the present invention also verifies whether the final diagnosis element complies with a plurality of regulations, as shown in FIG. 5. The regulations are preferably governmental (federal and state) regulations, though other regulations may apply. If the final diagnosis element complies with the regulations, the final diagnosis element is accepted and added to the patient analysis sheet. If the final diagnosis element does not comply with the regulations, the final diagnosis element is rejected and the user is prompted to select a new final diagnosis element that complies with the regulations.

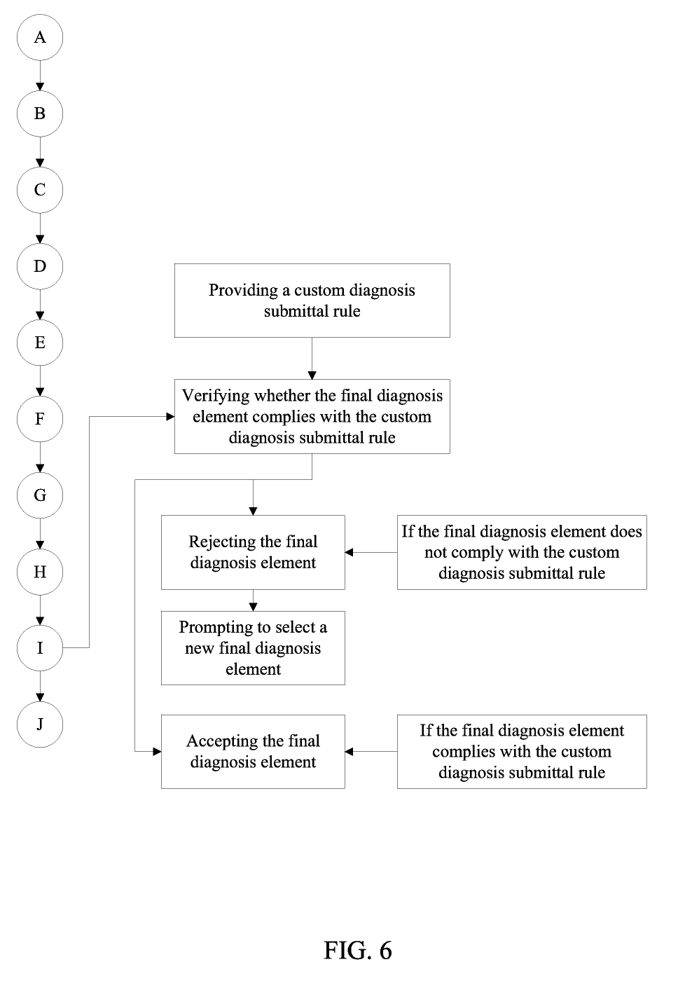

Finally, custom diagnosis submittal rules may be created, as described in FIG. 6. For example, with experience a practitioner may learn that a certain code or combination of codes has a high rate of rejection. Subsequently, the practitioner may create a custom diagnosis submittal rule to reject the code(s) with high rates of rejection. The present invention verifies whether the final diagnosis element complies with the custom diagnosis submittal rule. The final diagnosis element is accepted if the final diagnosis element complies with the custom diagnosis submittal rule. The final diagnosis element is rejected if the final diagnosis element does not comply with the custom diagnosis submittal rule, and the user is prompted to select a new final diagnosis element that complies with the custom diagnosis submittal rule.

Although the invention has been explained in relation to its preferred embodiment, it is to be understood that many other possible modifications and variations can be made without departing from the spirit and scope of the invention as hereinafter claimed.

What is claimed is:

1. A method of expediting medical diagnosis code selection by executing computer-executable instructions stored on a non-transitory computer-readable medium comprises the steps of:
providing a user interface;
providing a database of medical diagnosis codes,
wherein the database of medical diagnosis codes comprises a plurality of elements,
wherein the plurality of elements is organized in a branching hierarchy,
wherein each of the plurality of elements is associated with a hierarchal level;
prompting to select at least one desired element from the plurality of elements;
compiling each of the at least one desired element into a customized reference list;
displaying the customized reference list through the user interface;
prompting to select a preliminary diagnosis element from the customized reference list;
displaying subordinate elements for the preliminary diagnosis element from the database of medical diagnosis codes through the user interface;
prompting to graphically navigate through lower hierarchal levels of the subordinate elements in order to select a final diagnosis element from the database of medical diagnosis codes;
executing a verification process for the final diagnosis element; and
adding the final diagnosis element to a patient analysis sheet.

2. A method of expediting medical diagnosis code selection by executing computer-executable instructions stored on a non-transitory computer-readable medium as claimed in claim 1 comprises the step of:
graphically navigating through the branching hierarchy of the database of medical diagnosis codes in order to select the at least one desired element.

3. A method of expediting medical diagnosis code selection by executing computer-executable instructions stored on a non-transitory computer-readable medium as claimed in claim 1 comprises the steps of:
receiving a search query;
searching the database of medical diagnosis codes for the search query;
displaying a list of matching results; and
selecting the at least one desired element from the list of matching results.

4. A method of expediting medical diagnosis code selection by executing computer-executable instructions stored on a non-transitory computer-readable medium as claimed in claim 1 comprises the step of:
verifying the final diagnosis element as a leaf node, wherein a leaf node does not have subordinate elements in the branching hierarchy.

5. A method of expediting medical diagnosis code selection by executing computer-executable instructions stored on a non-transitory computer-readable medium as claimed in claim 4 comprises the step of:
rejecting the final diagnosis element, if the final diagnosis element is not a leaf node.

6. A method of expediting medical diagnosis code selection by executing computer-executable instructions stored on a non-transitory computer-readable medium as claimed in claim 4 comprises the step of:
prompting to select a new final diagnosis element from a subordinate hierarchal level, if the final diagnosis element is not a leaf node.

7. A method of expediting medical diagnosis code selection by executing computer-executable instructions stored on a non-transitory computer-readable medium as claimed in claim 1 comprises the step of:
verifying whether the final diagnosis element complies with a plurality of regulations.

8. A method of expediting medical diagnosis code selection by executing computer-executable instructions stored on a non-transitory computer-readable medium as claimed in claim 7 comprises the steps of:
accepting the final diagnosis element, if the final diagnosis element complies with the regulations;
rejecting the final diagnosis element, if the final diagnosis element does not comply with the regulations; and
prompting to select a new final diagnosis element, if the final diagnosis element does not comply with the regulations.

9. A method of expediting medical diagnosis code selection by executing computer-executable instructions stored on a non-transitory computer-readable medium as claimed in claim 1 comprises the steps of:
providing a custom diagnosis submittal rule; and
verifying whether the final diagnosis element complies with the custom diagnosis submittal rule.

10. A method of expediting medical diagnosis code selection by executing computer-executable instructions stored on a non-transitory computer-readable medium as claimed in claim 9 comprises the steps of:
accepting the final diagnosis element, if the final diagnosis element complies with the custom diagnosis submittal rule;
rejecting the final diagnosis element, if the final diagnosis element does not comply with the custom diagnosis submittal rule; and
prompting to select a new final diagnosis element, if the final diagnosis element does not comply with the custom diagnosis submittal rule.

11. A method of expediting medical diagnosis code selection by executing computer-executable instructions stored on a non-transitory computer-readable medium as claimed in claim 1 comprises the steps of:
displaying a plurality of customized reference sheets through the user interface;
selecting one of the customized reference sheets as a desired reference sheet; and
selecting the preliminary diagnosis element from the desired reference sheet.
